(19) United States
(12) Patent Application Publication
(10) Pub. No.: US 2002/0035049 A1
(43) Pub. Date: Mar. 21, 2002

(54) TOILET CLEANING BLOCK

(76) Inventors: SUSHEEL KUMAR SURI, NEW DELHI (IN); KUNAL MUKHOPADHYAY, CALCUTTA (IN)

Correspondence Address: FREDERICK H RABIN, FISH & RICHARDSON, 45 ROCKEFELLER PLAZA, NEW YORK, NY, 10111

(21) Appl. No.: 09/367,094

(22) PCT Filed: Feb. 20, 1998
(86) PCT No.: PCT/GB98/00368

(30) Foreign Application Priority Data
Feb. 20, 1997 (GB) 9703498.7

(51) Int. Cl. C11D 17/00

(52) U.S. Cl. 510/191; 510/447

(57) ABSTRACT

A composition, which is suitable for use as an ITC block is disclosed, which has advantageous properties related to in-use life span. The composition comprises: (a) 35 to 65% w/w of an anionic detergent (surfactant) selected from alkyl benzene sulphonic acids, alpha olefine sulfonates, long chain fatty acid sulphates, higher fatty acids, (is well as the alkali metal and alkaline earth metal salts thereof, and natural detersive agents, and mixtures of any of these; (b) 3 to 15% w/w of a non-ionic detergent (surfactant) selected from alkoxylated alkyl phenols and alkoxylated fatty alcohols, (c) 5 to 10% w/w of a water-swellable cellulose derivative or a salt thereof wherein the cellulose derivative exhibits a viscosity of at least about 1500 cps, measured in a 1% aqueous solution at 25° C. with a Brookfield viscometer (spindle 3, speed 30 rpm, factor 40 for viscosities of 2500-3500 cps); (d) 6 to 20% of a solubility regulator selected from alkali metal and alkaline earth metal chlorides, carbonates and sulphates., aluminosilicates and starch; and (e) 0 to 20% of a fragrance (perfume) in solid liquid or microencapsulated form. The composition may be prepared by mixing and extrusion.

The present invention relates to compositions suitable for use as toilet cleanser blocks, which allow for the inclusion of an increased concentration of perfume and have an increased in-use life span. In particular, this invention relates to their preparation by extrusion and their use in toilet cisterns.

Compositions, particularly in the form of blocks, are known for cleansing toilet systems by placing the block in the cistern (ITC) or toilet bowl (ITB), so that when the cistern is flushed, cleansing components are released with the flush water into the toilet bow. Such toilet cleansing blocks generally comprise one or more water-soluble detergents which, when released, render the flush water cleansing together with one or more relatively water-insoluble agents to retard the rate of dissolution of the block. Partly because the detergents and other ingredients are not very pleasant to smell and also because it is advantageous to provide a pleasant odour, it is common to add a perfume or fragrance to these blocks. These perfumes or fragrances are usually blends of various aromatic and non-aromatic compounds, and are usually immiscible with water.

However, many of these toilet cleanser blocks comprise a relatively low concentration of perfume because, at higher concentrations, there is a tendency for the fragrance to start oozing out from the block during manufacture, particularly if the quantity of other ingredients of the block are not properly maintained. Also, at higher concentrations, in use the perfume(s) may leach out as oily droplets on the surface of the water in the cistern in the case of ITC blocks.

Blocks have generally been manufactured by melting the ingredients and moulding the melt into the desired shape. British patent specification no. GB 2 021 143 describes an alternative method comprising forming a free-flowing mixture of certain ingredients and subsequently compressing the mixture to tablet form. However, when manufacturing involves an extrusion step (e.g. to form a rod-shaped block, rather than a tablet), rheological problems arise with the composition, probably due to the relatively low pressure (about 30-50 bars) applied during extrusion in comparison to that applied during tabletting. Consequently, extruded blocks tend to have a shorter life span than tablets of equivalent weight and composition, which tend to be harder than the corresponding blocks.

Therefore, there is a need to improve the life span, in use, of such extruded block compositions. Clearly, it is a disadvantage to have to replace toilet blocks at frequent, short intervals. The longer the length of time or the greater the number of cistern flushes over which such compositions can remain effective, the better for the consumer.

We have now surprisingly found a composition suitable for use as an ITC extruded block that allows a higher concentration of perfume to be incorporated and that allows consistent release of the perfume and other ingredients throughout an increased in-use life span of the block.

According to the present invention, there is therefore provided a composition comprising:

a) 35 to 65% w/w of an anionic detergent (surfactant) selected from alkyl benzene sulphonic acids, alpha olefine sulphonates, long chain fatty acid sulphates, higher fatty acids, as well as the alkali metal and alkaline earth metal salts thereof and natural detersive agents, and mixtures of any of these;

b) 3 to 15% w/w of a non-ionic detergent (surfactant) selected from alkoxylated alkyl phenols and alkoxylated fatty alcohols, particularly those which include an average of 2 to 5 ethoxy and/or propoxy groups per surfactant molecule;

c) 5 to 10% w/w of a water-swellable cellulose derivative or a salt thereof, wherein the cellulose derivative exhibits a viscosity of at least about 1500 cps, more preferably a viscosity of 1500-3500 cps, measured in a 1% aqueous solution at 25° C. with a Brookfield viscometer (spindle 3, speed 30 rpm, factor 40 for viscosities of 2500-3500 cps);

d) 6 to 20% w/w of a solubility regulator selected from alkali metal and alkaline earth metal chlorides, carbonates and sulphates, aluminosilicates and starch; and

e) 0 to 20% w/w of a fragrance (perfume).

All % w/w referred to herein are based on the weight of the total composition.

The anionic detergents (component (a)) for use in the compositions of the invention are powder based with good texturising properties, and are preferably linear C6-24 alkyl benzene sulphonic acids, alpha olefine sulphonates and/or natural detersive agents. Suitable natural detersive agents include saponified fatty acids having an anionic function, such as coconut soap powder, tallow soap powder, palm soap powder, palm kernel soap powder, soaps based on soya oil and/or sunflower oil, and mixtures of any of these. More preferably, the anionic detergents are the sodium salt of linear C6-24 alkyl benzene sulphonic acid (sodium LABSA), sodium lauryl sulphate and/or soap nut powder. Especially preferred is when the alkyl chain is C10-18, more especially C12-14, such as C12, for example, that available under the trade name Nansa HS 80 and Nansa LSS 80 from Albright & Wilson, UK. Preferably, the anionic detergent is present in the range of from 40 to 55%, more preferably about 50% w/w.

The non-ionic detergents (component (b)) for use in the compositions of the invention are also powder based and are preferably alkoxylated alkyl phenols, such as an ethoxylated nonyl phenol having 2 to 5 mols, such as 3 to 4.5 mols, of ethylene oxide per molecule. More preferably, the length of the alkyl chain of these detergents is in the range of from C8 to C18, especially C14 to C18, more especially C16 to C18, for example, that having a chain length of C14 to C16 such as those available under the trade name Synperonic from ICI, UK. Preferably, the non-ionic detergent is present in the range of from 4 to 8%, more preferably about 5 to 7% w/w.

The cellulose derivative (component (c)) is preferably carboxymethyl cellulose or a salt thereof although other derivatives such as hydroxyethyl cellulose and hydroxypropylmethyl cellulose may be used. It is more preferably present as the sodium salt thereof and preferably has a viscosity in the range of from around 2000 to 3500 cps (inclusive), more preferably 1500 to 2500 cps. Conveniently, the cellulose derivative has a pH in the range 7 to 8.5 (1% aqueous). Especially preferred is when the composition comprises about 6 to 10%, such as about 8% of the cellulose derivative. A preferred cellulose derivative for use in the compositions of this invention is available from Reliance Cellulose Products Ltd (Secunderabad), India, under the trade name Hercules SP 60.

The solubility regulator (component (d)) is preferably selected from alkali metal and alkaline earth metal chlorides and sulphates, although carbonates aluminosilicates (zeolites) and starch are also suitable. More preferably, anhydrous sodium sulphate is used. Preferably, the solubility regulator is present in the range of from 8 to 15%, more preferably 8 to 13%, especially 10 to 12% w/w.

The fragrance (component (e)) is preferably present in the range of from 5 to 16%, such as about 6% w/w and may be in solid, liquid or micro-encapsulated form.

Although particularly suitable for ITC use, these can also be used as ITB (in The Bowl) toilet cleanser blocks; for example, the compositions may be formulated as one month ITC or ITB toilet blocks.

Preferably the composition according to the invention is formulated as a toilet block of 25 to 75 g, more preferably 48 to 55 g, and is conveniently provided in a wrapper or envelope of a water-soluble polymer film, such as a film based on polyvinyl alcohol which dissolves on contact with water.

Compositions according to the invention optionally but preferably also comprise 1 to 10% w/w, preferably about 3 to 5%, more preferably about 5% of a limescale preventer or inhibitor, such as a tetrasodium salt of hydroxyethylidene-1,1-diphosphonic acid (HEDP) or of ethylene diamine tetra-acetic acid (EDTA). or salts (preferably sodium salts) of nitrilotetra-acetic, citric or gluconic acids.

Compositions according to the invention optionally but preferably also comprise 1 to 30% w/w, preferably 1 to 10%, more preferably 2 to 5%, especially about 2% of a foam booster and/or foam stabiliser, such as cocomonoethanolamide or a salt thereof.

Compositions according to the invention optionally but preferably also comprise 4 to 10% w/w, preferably 4 to 8%, more preferably 5 to 7% especially about 5% of one or more inert fillers, such as those selected from silica, bentonites and clays, starch and alkali metal sulphates and carbonates. Preferably, silica is chosen and, more preferably, any fragrance present is adsorbed onto the silica particles.

Compositions according to the invention optionally but preferably also comprise 0.3 to 10% w/w, preferably 0.3 to 5%, more preferably 0.5 to 2%, especially about 0.5%, of a germicide or disinfectant, such as those selected from trichlorocarbanilide, triclosan, para-dichlorobenzene, para-chlorometa-xylenol, ortho-benzyl-p-dichlorophenol and benzyl cresol.

Compositions according to the invention optionally but preferably also comprise 1 to 10% w/w, preferably 5 to 7%, more preferably about 6% of a colourant or pigment, such as a water-dispersible or water-soluble dye. Examples of such dyes are acid dyes, for example acid blue dyes, in liquid or solid form.

Compositions according to the invention have been found to have consistently good performance with regard to perfume-, foam- and colour-releasing properties during in-the-cistern usage, that is to say that the performance (efficiency) of the block is substantially uniform over its life.

The toilet blocks can be made by a combination of conventional steps from the known components. For example, they are conveniently formed by a process which comprises mixing, extrusion and cutting, optionally followed by compression/tabletting. Where a filler such as silica and a fragrance are used together, as is preferred, there may be an additional step comprising coating of the filler with the fragrance.

The preferred process comprises providing a matrix of the water-swellable cellulose derivative (component (c)) having micro-channels or micelles therein and depositing therein the anionic and non-ionic detergents (components (a) and (b)) and optionally other components (especially the dye, foaming agent (foam booster) and the like). The water-swellable cellulose derivative thereby acts as a controlled or slow release agent, controlling the release of the detergents and other components, rather than conventionally as a binder for tabletting.

Therefore, the present invention further provides a method of manufacturing a toilet block, which method comprises bringing into physical admixture

(a) 35 to 65% w/w of an anionic detergent (surfactant) selected from alkyl benzene sulphonic acids, alpha olefin sulphonates, long chain fatty acid sulphates, higher fatty acids, as well as the alkali metal and alkaline earth metal salts thereof, and natural detersive agents, and mixtures of any of these;

(b) 3 to 15% w/w of a non-ionic detergents (surfactants) selected from alkoxylated alkyl phenols and alkoxylated fatty alcohols;

(c) 5 to 10% w/w of a water-swellable cellulose derivative or a salt thereof, wherein the cellulose derivative exhibits a viscosity of at least about 1500 cps, measured in a 1% aqueous solution at 25° C. with a Brookfield viscometer (spindle 3, speed 30 rpm, factor 40 for viscosities of 2500-3500 cps);

(d) 6 to 20% of a solubility regulator selected from alkali metal and alkaline earth metal chlorides, carbonates and sulphates, aluminosilicates and starch; and

(e) 0 to 20% of a fragrance (perfume);

and extruding the mixture thereby formed; and optionally thereafter compressing the resulting extrusion. 5 The mixture to be extruded should contain 5-25% w/w by weight of a liquid component or a solid component which liquefies under extrusion conditions to act as processing aid. Such processing aids may be chosen from appropriate ingredients mentioned hereinbefore, especially the non-ionic detergent, perfume and any foam booster, or other excipients known to be effective for the purpose.

The resultant blocks may be wrapped into water-soluble PVA cloth and pleat-wrapped with a thermally-controlled heater/pleating machine before being packed into PVC blister packaging to protect them from moisture and other atmospheric gases.

The present invention therefore further provides the use of an extruded block composition according to the invention for cleansing toilets: and a method of cleansing toilets, which method comprises bringing an extruded block according to the present invention in contact with toilet flush water. such as by placing the block in the cistern or in the bowl of the toilet.

The invention will now be illustrated by the following Examples.

### EXAMPLE 1

### Extruded Toilet Block for In-The-Cistern Use

A composition is made up by mixing the following components together, according to the method set out below.

| | w/w |
|---|---|
| Ingredient | composition |
| Sodium salt of linear alkyl | 50.0% |
| benzene sulphonic acid (anionic detergent) | |
| Ethoxylated nonyl phenol | 5.0% |
| having 4.5 moles of ethylene oxide (nonionic detergent) | |
| Cocomonoethanolamide (foam booster) | 2.0% |
| Sodium carboxymethyl cellulose (slow release substance) | 8.0% |
| Tetrasodium HEOP (limescale preventer) | 5.0% |
| Trichlorocarbanilide (disinfectant) | 0.5% |
| Acid blue 1 (dye) | 6.0% |
| Lavender (fragrance) | 6.0% |
| Anhydrous sodium sulphate (solubility regulator) | 12.5% |
| Silica powder(fragrance-coating agent) | 5.0% |

Blocks with the above composition are conveniently formed by a four step process, as follows:

Coating of fragrance: The silica is taken in a vessel and the fragrance is sprayed by a spray gun with continuous mixing until the total fragrance is uniformly coated onto the silica.

Mixing: The required quantity of sodium salt of linear alkyl benzene sulphonic acid [or other anionic detergent(s)] is loaded in a Sigma mixer. The non-ionic detergent (ethoxylated nonyl phenol/fatty alcohol) is slowly added to it with continous mixing until a semi-solid, homogenous mass is obtained

The fragrance-coated silica and the solubility regulator (anhydrous sodium sulphate) are added to the mixer and mixed for about 10 minutes to ensure homogeneity. Separately, the cocomonoethanolamide (foam booster) is passed through a triple roller mill, added to the mixer and mixed for 5 minutes.

The trichlorocarbanilide (germicide) and tetrasodium HEDP (limescale preventer) are added and mixed for 5-7 minutes. The sodium carboxymethyl cellulose is then added and mixed for 7 minutes. The colour is finally added and mixed until a semi-solid dough is obtained. It is to be understood that a different order of addition of components to the mixer is feasible.

Extrusion: The mass is then transferred to a plodder/extruder and drawn in form of rod (although other shapes may be used if desired).

Cutting and compression: The rod is cut by means of a suitable cutter to appropriate block weight and the individual block is subjected to suitable die cavities and compressed with 2 to 15 tonne pressure into final shape.

The mixture to be extruded should contain 5-25% by weight of a liquid or a solid component which liquefies under extrusion pressure conditions (2-15 tonnes) to act as lubricant processing aid. In this composition, the ethoxylated nonyl phenol, cocomonoethanolamide and fragrance provide this.

The resultant blocks are wrapped into water-soluble PVA cloth and pleat-wrapped with a thermally controlled heater/pleating machine. This is finally packed into PVC blister packaging to protect it from moisture and other atmospheric gases.

### EXAMPLE 2

### Extruded Toilet Block for In-The-Cistern Use

A composition is made up by mixing and extruding the following components together by a method analogous to that of Example 1.

| | w/w |
|---|---|
| Ingredient | composition |
| Sodium salt of linear alkyl | 25.0% |
| benzene sulphonic acid (anionic detergent) | |
| Sodium lauryl sulphate | 25.0% |
| Ethoxylated nonyl phenol | 5.0% |
| having 4.5 moles of ethylene oxide (nonionic detergent) | |
| Sodium carboxymethyl cellulose (slow release substance) | 8.0% |
| Tetrasodium HEOP (limescale preventer) | 5.0% |
| Trichlorocarbanilide (disinfectant) | 0.5% |
| Acid blue 1 (dye) | 6.0% |
| Lavender (liquid fragrance) | 6.0% |
| Solid fragrance | 6.0% |
| Anhydrous sodium sulphate (solubility regulator) | 8.5% |
| Silica powder (fragrance-coating agent) | 5.0% |

### EXAMPLE 3

### Extruded Toilet Block for In-The-Cistern Use

A composition is made up by mixing and extruding the following components together by a method analogous to that of Example 1.

| | w/w |
|---|---|
| Ingredient | composition |
| Sodium salt of linear alkyl | 40.0% |
| benzene sulphonic acid (anionic detergent) | |
| Ethoxyfated fatty alcohol | 5.0% |
| having 3 moles of ethylene oxide (nonionic detergent) | |
| Soap nut powder (natural detergent) | 10.0% |
| Sodium carboxymethyl cellulose (slow release substance) | 8.0% |
| Tetrasodium HEDP (limescale preventer) | 5.0% |
| Trichlorocarbanilide (disinfectant) | 0.5% |
| Acid blue 1 (dye) | 6.0% |
| Lavender (fragrance) | 6.0% |
| Anhydrous sodium sulphate (solubility regulator) | 14.5% |
| Silica powder(fragrance-coating agent) | 5.0% |

### Example 4

### Extruded Toilet Block for In-The-Cistern Use

In a similar manner to that described for Example 1, but omitting the silica-coating step, the following ingredients were formulated into an extruded ITC block.

| | w/w |
|---|---|
| Ingredient | composition |
| Sodium salt of linear alkyl | 50% |
| benzene sulphonic acid (anionic surfactant) | |
| Ethoxylated nonyl phenol | 5% |
| having 4.5 moles of ethylene oxide (non-ionic surtactant) | |
| Cocomonoethanolanhide (foam booster) | 2% |
| Sodium carboxymethyl cellulose (dissolution control | 8% |
| agent) | |
| Tetrasodium HEDP (limescale preventer/inhibitor) | 5% |
| Trichiorocarbanilide (germicidal agent) | 0.5% |
| Acid Blue No 1 (colourant) | 6% |
| Lavender in liquid (fragrance) | 6% |
| Anhydrous sodium sulphate (solubility regulator) | 17.5% |

### Example 5

### Extruded Toilet Block for In-The-Bowl Use

In a similar manner to that described for Example 1, the following ingredients were formulated into an extruded ITB block.

| | w/w |
|---|---|
| Ingredient | composition |
| Nansa HS 80 (linear alkyl | 48% |
| sulphonate, 80%) (anionic surfactant) | |
| Nansa LSS 80 (alphaolefin sulphonate, 80%) (anionic | 10% |
| surfactant) | |
| Nonylphenol, ethoxylated with 4.5 mols ethylene oxide | 8% |
| (non-ionic surfactant, ICI) | |
| Sodium carboxymethyl cellulose (dissolution control | 6% |
| agent) | |
| Silica powder (fragrance-coating agent) | 4% |
| Perfume | 8% |
| Anhydrous sodium sulphate (solubility regulator) | 12% |
| Sodium citrate | 4% |

### Example 6

### Extruded Toilet Block for In-The-Bowl Use

In a similar manner to that described for Example 1, the following ingredients were formulated into an extruded ITB block.

| Ingredient | w/w composition |
|---|---|
| Nansa HS 80 (linear alkyl | 30% |
| sulphonate, 80%) (anionic surfactant) | |
| Nansa LSS 80 (alphaolefin sulphonate) | 10% |
| (non-ionic surfactant) | |
| Nonylphenol, ethoxylated with 4.5 mols | 8% |
| ethylene oxide (non-ionic surfactant, ICI) | |
| Sodium carboxymethyl cellulose | 10% |
| (dissolution control agent) | |
| Silica powder (fragrance-coating agent) | 6% |
| Perfume | 20% |
| Anhydrous sodium sulphate | 12% |
| (solubility regulator) | |
| Sodium citrate | 4% |

1. A composition suitable for use as an extruded ITC or ITB block, comprising
(a) 35 to 65% w/w of an anionic detergent (surfactant) selected from alkyl benzene sulphonic acids, alpha olefine sulphonates, long chain fatty acid sulphates, higher fatty acids, as well as the alkali metal and alkaline earth metal salts thereof and natural detersive agents, and mixtures of any of these;
(b) 3 to 15% w/w of a non-ionic detergent (surfactant) selected from alkoxylated alkyl phenols and alkoxylated fatty alcohols.
(c) 5 to 10% w/w of a water-swellable cellulose derivative or a salt thereof, wherein the cellulose derivative exhibits a viscosity of at least about 1500 cps, measured in a 1% aqueous solution at 25° C. with a Brookfield viscometer (spindle 3, speed 30 rpm, factor 40 for viscosities of 2500-3500 cps);
(d) 6 to 20% w/w of a solubility regulator selected from alkali metal and alkaline earth metal chlorides, carbonates and sulphates aluminosilicates and starch; and
(e) 0 to 20% w/w of a fragrance (perfume).

2. A composition according to claim 1 or claim 2, wherein the cellulose derivative has a viscosity in the range of from 1500 to 2500 cps (inclusive).

3. A composition according to claim 1, wherein the cellulose derivative is carboxymethylcellulose or a salt thereof.

4. A composition according to any preceding claim, wherein the anionic detergent (component (a)) is selected from powder based linear C6-24 alkylbenzene sulphonic acids, alpha olefine sulphonates, sodium lauryl sulphate and natural detersive agents, and mixtures thereof.

5. A composition according to any preceding claim, wherein the non-ionic detergent (component (b)) is selected from powder based alkoxylated alkyl phenols having 2 to 5 mols, such as 3 to 4.5 mols, of ethylene oxide per molecule.

6. A composition according to any preceding claim, which further comprises one or more or the following:
(a) 1 to 10% w/w of a limescale preventer or inhibitor;
(b) 1 to 30% w/w of a foam booster and/or foam stabiliser;
(c) 4 to 10% w/w of one or more inert fillers;
(d) 0.3 to 10% w/w of a germicide or disinfectant;
(e) 1 to 10% w/w of a colourant or pigment.

7. A composition according to any preceding claim, wherein the perfume or fragrance is adsorbed onto silica.

8. A composition according to any preceding claim, comprising, based on w/w total composition:
(a) 25 to 65% of a powder-based sodium salt of linear C6-24 alkyl benzene sulphonic acid and/or alpha olefine sulphonates;
(b) 4 to 8% of a powder-based nonylphenol ethoxylated with 2 to 5 mols of ethylene oxide;
(c) 6 to 10% of the sodium salt of carboxymethylcellulose in which the polymer chain is such that the viscosity of a 1% solution in water is in the range of 2000 to 3500 (inclusive) cps at 25° C.;
(d) 8 to 18% of anhydrous sodium sulphate;
(e) 5 to 16% of fragrance;
(f) 3 to 10% of tetrasodium hydroxyethylidene-1,1-diphosphonic acid;
(g) 1 to 10% of cocomonoethanolamide;
(h) 4 to 8% of silica;
(i) 3 to 5% of trichlorocarbanilide; and
(j) 5 to 10% of acid blue dye.

9. A method of manufacturing a toilet block, which method comprises bringing into physical admixture
(a) 35 to 65% w/w of an anionic detergent (surfactant) selected from alkyl benzene sulphonic acids, alpha olefine sulphonates, long chain fatty acid sulphates, higher fatty acids, as well as the alkali metal and alkaline earth metal salts thereof, and natural detersive agents, and mixtures of any of these;
(b) 3 to 15% w/w of a non-ionic detergent (surfactant) selected from alkoxylated alkyl phenols and alkoxylated fatty alcohols;
(c) 5 to 10% w/w of a water-swellable cellulose derivative or a salt thereof, wherein the cellulose derivative exhibits a viscosity of at least about 1500 cps, measured in a 1% aqueous solution at 25° C. with a Brookfield viscometer (spindle 3, speed 30 rpm, factor 40 for viscosities of 2500-3500 cps);
(d) 6 to 20% of a solubility regulator selected from alkali metal and alkaline earth metal chlorides, carbonates and sulphates, aluminosilicates and starch; and
(e) 0 to 20% of a fragrance (perfume);
and extruding the mixture thereby formed; and optionally thereafter compressing the resulting extrusion.

10. A method according to claim 9, comprising the further step of adsorbing the fragrance onto in the range of from 4 to 10% w/w inert filler, such as silica.
